(19) United States
(12) Patent Application Publication
(10) Pub. No.: US 2008/0060474 A1
(43) Pub. Date: Mar. 13, 2008

(54) Gearless Differential in an Integrated Hydrostatic Transmission

(76) Inventors: Katsumoto MIZUKAWA, Hyogo (JP); Jun Matsuura, Hyogo (JP); Norihiro Ishii, Hyogo (JP); Hiroaki Shimizu, Hyogo (JP)

Correspondence Address: STERNE, KESSLER, GOLDSTEIN & FOX P.L.L.C., 1100 NEW YORK AVENUE, N.W., WASHINGTON, DC, 20005, US

(21) Appl. No.: 11/470,851

(22) Filed: Sep. 7, 2006

(51) Int. Cl. F16D 21/06; F16D 23/00

(52) U.S. Cl. 74/650

(57) ABSTRACT

An improved differential unit for an integrated hydrostatic transmission (IHT) is provided. The differential unit comprises an input gear, a cross-shaft disposed within a central opening of the input gear, and a pair of clutch members disposed coaxial with the input gear. One of each clutch member is disposed on opposite sides of the cross-shaft. A first plurality of friction members extend from each clutch member. The differential unit also comprises a pair of side couplings, each coaxially disposed within one of the clutch members, and a second plurality of friction members extending from each side coupling. Each clutch member includes a cam surface that comes in contact with the cross-shaft when the differential unit is under normal operating conditions. Alternative embodiments are also described herein.

### BACKGROUND OF THE INVENTION

1. Field of the Invention

The present invention relates to an axle driving apparatus. More specifically, the present invention relates to a gearless differential provided within an integrated hydrostatic transmission.

2. Background Art

A hydrostatic transaxle apparatus called an integrated hydrostatic transmission (IHT) comprises a hydrostatic transmission (including a hydraulic pump and hydraulic motor; the combination hereinafter referred to as an “HST”), an axle, and a drive train interposed between the HST and the axle, all disposed together in a common housing. Many drive trains include a differential unit which permits independent or differential rotation of the drive wheels when the vehicle turns. Certain conditions, however, require the differential unit to be “locked” in order to transmit adequate torque to the axle. Various locking differentials have been proposed in, for example, U.S. Pat. Nos. 2,555,044, 5,413,015, 5,590,572, 5,727,430, 5,715,733, and 6,688,194, all of which are hereby incorporated by reference in their entirety.

### BRIEF SUMMARY OF THE INVENTION

Presented herein is an improved differential unit for an integrated hydrostatic transmission (IHT). In accordance with one aspect of the present invention, there is provided an axle driving apparatus comprising a housing, an HST contained within the housing, a gearless differential unit contained within the housing and drivingly connected to the output shaft of the HST, and a pair of axle shafts driven by the differential unit. The housing includes oil for the input gear to soak. The gearless differential unit comprises an input gear having a central opening, a cross-shaft disposed within the central opening of the input gear, and a pair of clutch members disposed coaxial with the input gear. One of each clutch member is disposed on opposite sides of the cross-shaft. A first plurality of friction members extends from each clutch member. The differential unit further comprises a pair of side couplings, each coaxially disposed within one of the clutch members. A second plurality of friction members extends from each side coupling. At least one of the second plurality of friction members is disposed proximate one of the first plurality of friction members for selective engagement therewith. In addition, each clutch member includes a cam surface that comes in contact with the cross-shaft when the differential unit is under normal operating conditions.

In one embodiment, the axle driving apparatus further includes a differential housing encasing the input gear, clutch members, and side couplings. In alternative embodiments, the cross-shaft has varying cross-sectional configurations to provide adequate contact between the cross-shaft and the cam surface. The housing includes oil for the input gear to soak. Further, in other alternative embodiments, oil channels and/or oil bores are created on the surfaces of the input gear and/or differential housing to facilitate the circulation of oil through the differential unit. In addition, in one embodiment, one clutch member includes at least one receiving slot, and the other clutch member includes at least one locking means extending therefrom. The locking means is aligned with the receiving slot in the other clutch member so as to form a loose interlock between the clutch members. In an additional embodiment, a spring is disposed within a receiving slot to bias the two clutch members apart.

In accordance with another aspect of the present invention, there is provided a differential unit for driving a pair of axle shaft segments. The differential unit is comprised of an input gear and a pair of clutch members disposed coaxial with the input gear and on opposite sides of the input gear. The input gear has a central opening, and a protrusion extending from each side surface of the input gear. Each clutch member has a cam surface aligned proximate with the protrusion extending from the respective side surface of the input gear for selective engagement. The clutch members are also loosely interlock with each other through the central opening of the input gear. The differential unit further comprises a first plurality of friction members extending from each clutch member, a pair of side couplings, each coaxially disposed within one of the clutch members, and a second plurality of friction members extending from each side coupling. At least one of the second plurality of friction members is disposed proximate one of the first plurality of friction members for selective engagement.

In accordance with yet another aspect of the present invention, there is provided an alternative differential unit for driving a pair of axle shaft segments. Such differential unit is comprised of an input gear and a pair of clutch members disposed coaxial with the input gear and on opposite sides of the input gear. The input gear of the alternative differential unit, however, has a central opening and a cam surface on each side surface of the input gear. Each clutch member has a protrusion extending from a surface of the clutch member. The protrusion on each clutch member is aligned with the cam surface on the respective side surface of the input gear for selective engagement therewith. The clutch members are loosely interlocked with each other through the central opening of the input gear. The differential unit further comprises a first plurality of friction members extending from each clutch member, a pair of side couplings, each coaxially disposed within one of the clutch members, and a second plurality of friction members extending from each side coupling. At least one of the second plurality of friction members is disposed proximate one of the first plurality of friction members for selective engagement.

### BRIEF DESCRIPTION OF THE DRAWINGS/FIGURES

The accompanying figures, which are incorporated herein and form part of the specification, illustrate an axle driving apparatus. Together with the description, the figures further serve to explain the principles of the axle driving apparatus described herein and thereby enable a person skilled in the pertinent art to make and use the axle driving apparatus.

FIG. 1 is a cross-sectional view of an integrated hydrostatic transmission (IHT) employing a differential unit in accordance with one embodiment of the present invention.

FIG. 2 is a cross-sectional view of the differential unit of FIG. 1.

FIGS. 3A and 3B are a side view and a perspective view, respectively, of the input gear of the differential unit of FIG. 2.

FIGS. 4A and 4B are a side view and a perspective view, respectively, of a clutch member of FIG. 2.

FIGS. 5A and 5B are a side view and a perspective view, respectively, of an alternative clutch member.

FIG. 6 is a partial cross-sectional view of a differential unit employing the clutch members of FIG. 5.

FIGS. 7A-D show alternative cross-shafts for use in the differential unit of the present invention.

FIGS. 8A and 8B are a side view and a perspective view, respectively, of an alternative clutch member.

FIG. 9 is a side view, partially in cross-section, of a differential unit employing the cross-shaft of FIG. 7D.

FIG. 10 is a cross-sectional view of a differential unit employing the cross-shaft of FIG. 7D.

FIGS. 11A-C are enlarged views of the contact surface between a cam surface of a clutch member and a cross-shaft of the present invention.

FIG. 12 is a longitudinal sectional view of a differential unit employing the cross-shaft of FIG. 7B.

FIGS. 13A-D are side views and a perspective views, respectively, of alternative input gears.

FIGS. 14A and 14B are a side view and a perspective view, respectively, of an alternative clutch member.

FIGS. 15A-D are side views and a perspective views, respectively, of alternative clutch members.

FIGS. 16A and 16B are a side view and a perspective view, respectively, of an alternative clutch member.

FIGS. 17A and 17B are a side view and a perspective view, respectively, of an alternative input gear.

FIGS. 18A and 18B are a side view and a perspective view, respectively, of an alternative clutch member.

FIGS. 19A and 19B are a side view and a perspective view, respectively, of an alternative clutch member.

FIGS. 20A and 20B are a side view and a perspective view, respectively, of a differential housing.

FIG. 21A is a cross-sectional view of lubrication oil in the differential apparatus.

FIG. 21B is a cross-sectional view taken along line A-A of FIG. 21A.

FIG. 22 is a side view and a perspective view of a housing having ditches for draining oil.

FIG. 23 is a four-wheel-drive vehicle employing a differential unit as presented herein.

FIG. 24 is a two-wheel-drive vehicle employing a differential unit as presented herein.

FIG. 25 is a cross-sectional view of an IHT employing an alternative differential unit.

FIG. 26 is a cross-sectional view of the IHT of FIG. 25.

FIG. 27 is a cross-sectional view of the differential unit of FIG. 25.

FIG. 28 is an exploded view of the differential unit of FIG. 25.

FIG. 29 is a cross-sectional view of an IHT incorporating an alternative differential unit.

FIG. 30 is a cross-sectional view of the differential unit of FIG. 29.

FIG. 31 is an exploded view of the differential unit of FIG. 29.

### DETAILED DESCRIPTION OF THE INVENTION

Preferred embodiments of an axle driving apparatus are described below with reference to the figures where like reference numbers indicate identical or functionally similar elements. Also in the figures, the left most digit of each reference number corresponds to the figure in which the reference number is first used. While specific configurations and arrangements are discussed, it should be understood that this is done for illustrative purposes only. A person skilled in the relevant art will recognize that other configurations and arrangements can be used without departing from the spirit and scope of the appended claims.

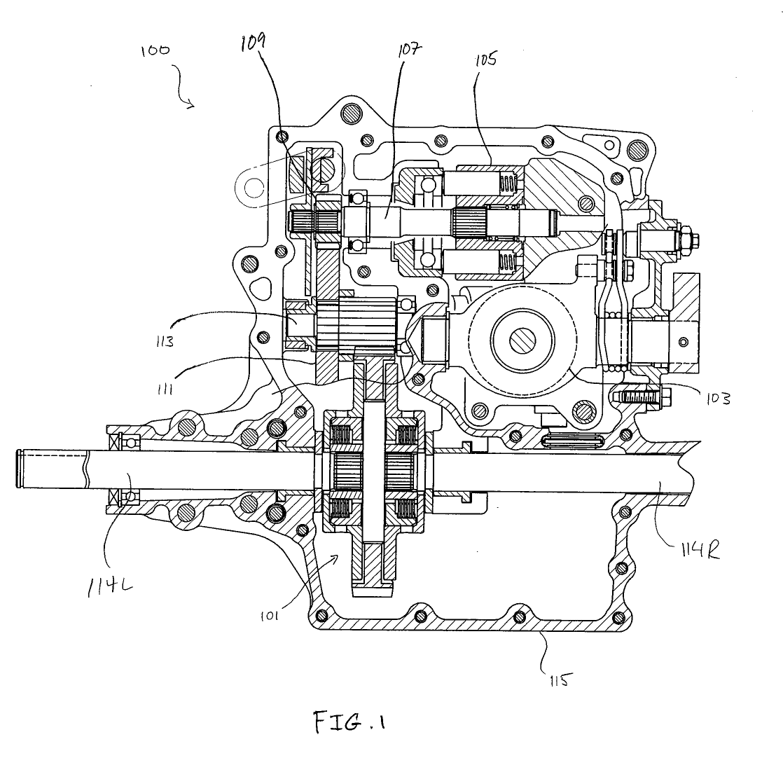

FIG. 1 depicts an integrated hydrostatic transmission (IHT) 100 employing a differential unit 101 in accordance with one embodiment of the present invention. IHT 100 includes a hydraulic pump 103 (shown in phantom) and a hydraulic motor 105 fluidly connected to the hydraulic pump 103. A similar construction is shown in U.S. Pat. No. 6,007,449, which is hereby incorporated by reference in its entirety. Hydraulic motor 105 includes an output shaft, or motor shaft 107. Splined gear 109 is mounted on motor shaft 107, to thereby rotate with motor shaft 107. Splined gear 109 meshes with gear 111 mounted on countershaft 113. Rotation of countershaft 113 thereby transmits rotational drive to differential unit 101. Differential unit 101 thereafter differentially drives axle shafts 114L and 114R. The components of IHT 100 are all appropriately mounted and maintained within IHT housing 115. Housing 115 includes oil for an input gear to soak.

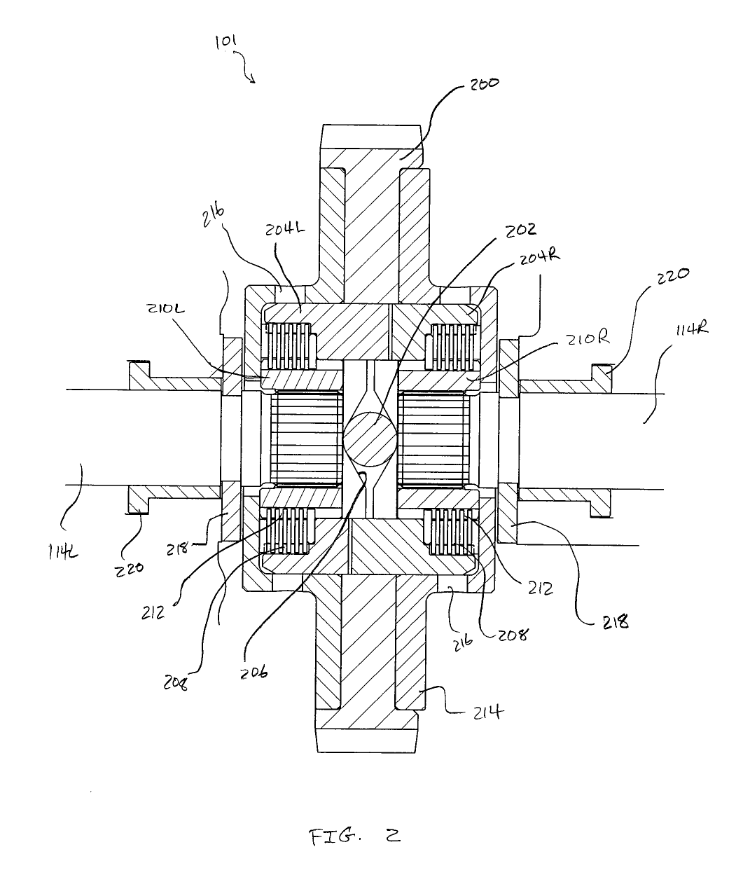

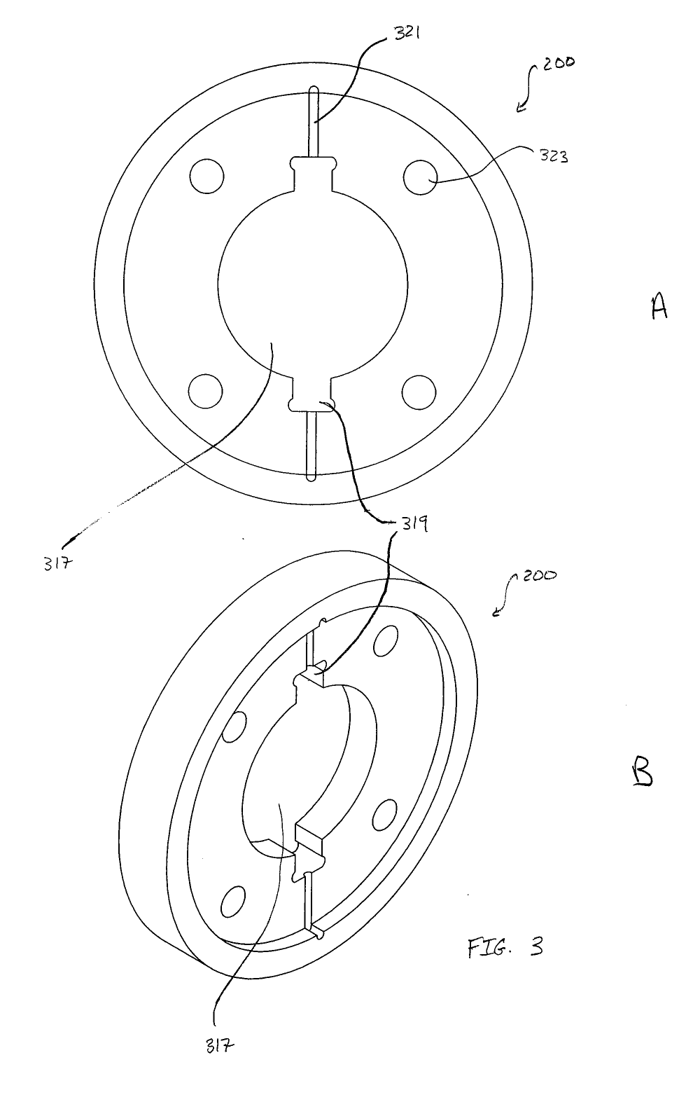

FIG. 2 is a cross-sectional view of differential unit 101 of FIG. 1. Differential unit 101 includes an input gear 200 having a central opening (as shown in FIG. 3). A cross-shaft 202 is disposed within the central opening of the input gear 200 and is interlocked with the input gear such that rotation of the input gear rotates the cross-shaft. A pair of clutch members 204L, 204R are disposed coaxial with input gear 200. Clutch members 204L, 204R are disposed on opposite sides of cross-shaft 202.

Each clutch member 204L, 204R includes a cam surface 206 which comes in contact with the cross-shaft 202 when the differential unit 101 is traveling forward under normal operating conditions. Each clutch member 204L, 204R also includes a first plurality of friction members 208 extending from therefrom.

Differential unit 101 also includes a pair of side couplings 210L, 210R. Each side coupling 210L, 210R is coaxially disposed within one of the clutch members 204L, 204R. A second plurality of friction members 212 extend from each side coupling 210L, 210R. The first and second plurality of friction members 208, 212 are disposed proximate one another for selective engagement therewith. Side couplings 210L, 210R are also internally splined to mesh with the splined ends of axle shafts 114L, 114R.

In operation, rotation of input gear 200 results in rotation of cross-shaft 202. As cross-shaft 202 moves forward (or backward) within the space provided between cam surfaces 206 of clutch members 204L, 204R, cross-shaft 202 contacts cam surfaces 206 and biases clutch members 204L, 204R apart. The outward biasing of clutch members 204L, 204R results in frictional engagement of the first and second plurality of friction members 208, 212. Such frictional engagement thereafter rotates side couplings 210L, 210R, which results in the rotation of axle shafts 114L, 114R. When one axle shaft (114L or 114R) rotates faster than the input gear, as happens when a vehicle is turning, the respective clutch member (204L or 204R) rotates faster than the cross-shaft 202, disengages with the cross-shaft 202, is maintained in a disengaged condition by a locking means (described below), and thereafter disengages the respective axle shaft 114L or 114R from differential unit 101.

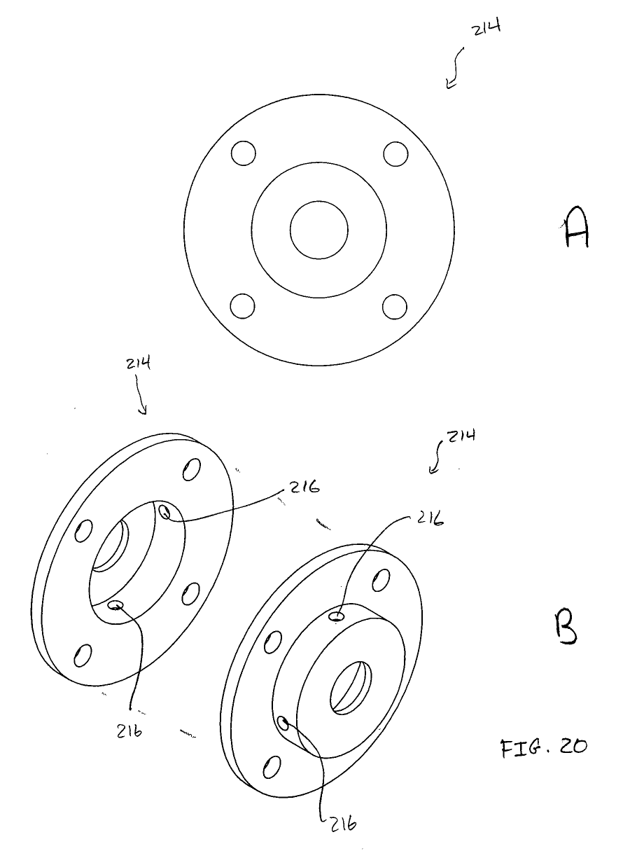

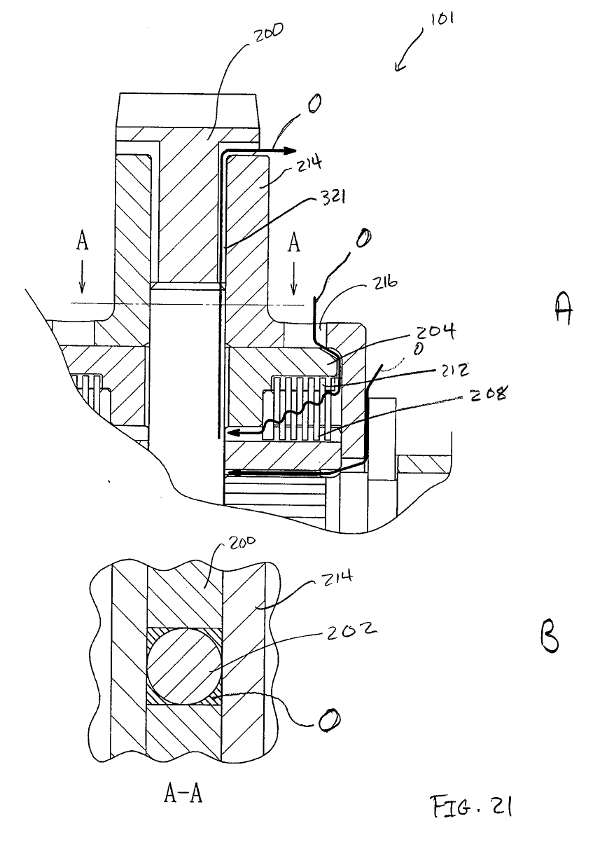

A differential housing 214 encases the input gear 200, clutch members 204L, 204R, and side couplings 210L, 210R. Differential housing 214 is maintained within IHT housing 115 and on the axle shafts 114L, 114R supported by washers 218 and bushes 220, respectively. As such, differential housing 214 thereby serves to align the components of the differential unit 101. Differential housing 214 also includes oil bores 216 to facilitate the circulation of oil through the differential unit 101. FIGS. 20A and 20B are a side view and a perspective view, respectively, of differential housing 214. FIG. 21A depicts the flow of lubrication oil in differential unit 101. As shown by the arrows, lubrication oil O is drained by centrifugal force through oil channels 321 and is then sucked through oil bores 216. As such, lubricating oil is circulated through differential unit 101, and more specifically through friction members 208, 212.

FIGS. 3A and 3B are a side view and a perspective view, respectively, of the input gear 200 of the differential unit 101 of FIG. 2. Input gear 200 has a central opening 317 for receiving cross-shaft 202 and clutch members 204L, 204R. Central opening 317 includes receiving grooves 319 for receiving the ends of cross-shaft 202. As such, cross-shaft 202 is interlocked with input gear 200 such that rotation of input gear 200 rotates cross-shaft 202. Input gear 200 further includes oil channels 321 to facilitate the circulation of oil through the differential unit 101. Bores 323 are used to bolt the sides of differential housing 214 to input gear 200.

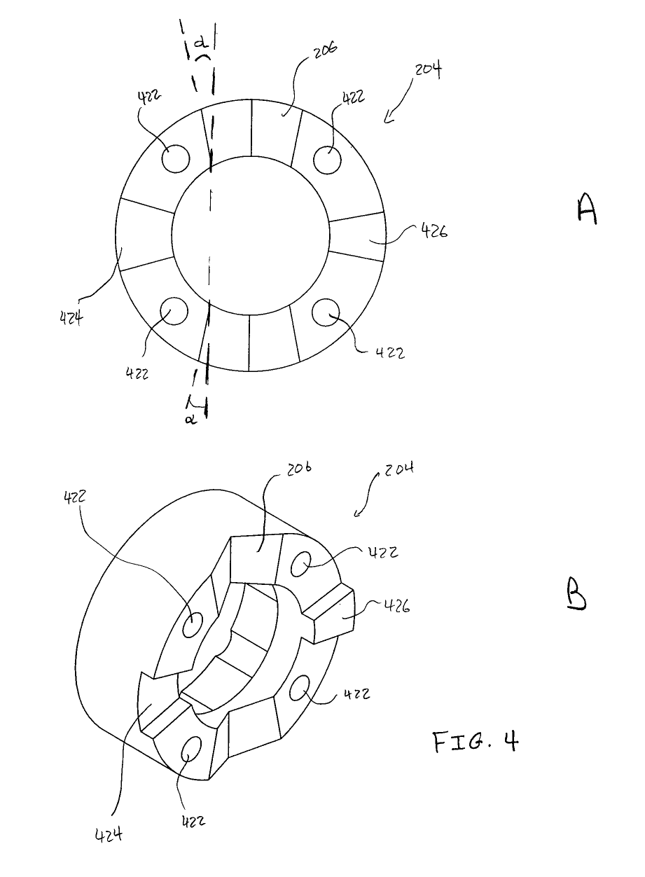

FIGS. 4A and 4B are a side view and a perspective view, respectively, of clutch member 204 of FIG. 2. Clutch member 204 includes angled cam surface 206. Specifically, the side walls of cam surface 206 are set at an angle a for complete contact with cross-shaft 202 when the cross-shaft is moved forward within the space provided between the two cam surfaces 206 on clutch members 204L, 204R. In a preferred embodiment, one clutch member (204L or 204R) includes at least one receiving slot, and the opposite clutch member (204R or 204L) includes a locking means extending therefrom. For example, as shown in FIG. 4, clutch member 204 has a receiving slot in the form of a receiving wedge 424. Clutch member 204 also includes a locking means in the form of locking wedge 426. In operation, the locking means of one clutch member is aligned with the receiving slot in the other clutch member so as to form a loose interlock between the clutch members. For example, the locking wedge 426 of clutch member 204L is aligned with and disposed within the receiving wedge 424 of clutch member 204R, and vice-versa, so as to form a loose interlock between clutch members 204L and 204R. At least one of receiving bores 422 is used to house a biasing spring, which functions to bias the two clutch members 204R, 204L apart.

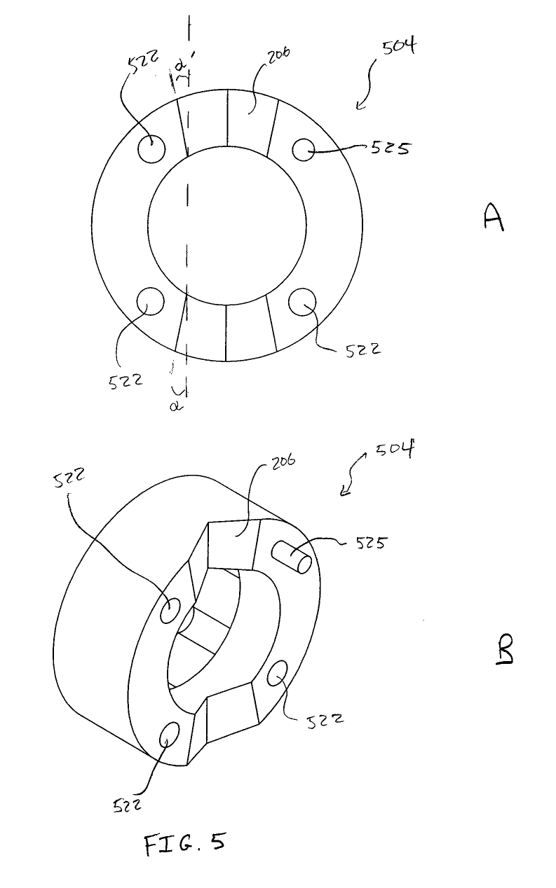

FIGS. 5A and 5B are a side view and a perspective view, respectively, of an alternative clutch member 504. Clutch member 504 includes angled cam surface 206. Specifically, the side walls of cam surface 206 are set at an angle α for complete contact with cross-shaft 202 when the cross-shaft is moved forward within the space provided between the two cam surfaces 206 on clutch members 504L, 504R. Clutch member 504 also includes a plurality of receiving slots in the form of receiving bores 522. Clutch member 504 differs from clutch member 204 in that the locking means of clutch member 504 takes the form of a locking pin 525 that extends from clutch member 504. In operation, the locking pin 525 of clutch member 504L is aligned with and disposed within a receiving bore 522 in clutch member 504R, and vice-versa, so as to form a loose interlock between clutch members 504L and 504R. At least one of the other receiving bores 522 is used to house a biasing spring, which functions to bias the two clutch members 504R, 504L apart.

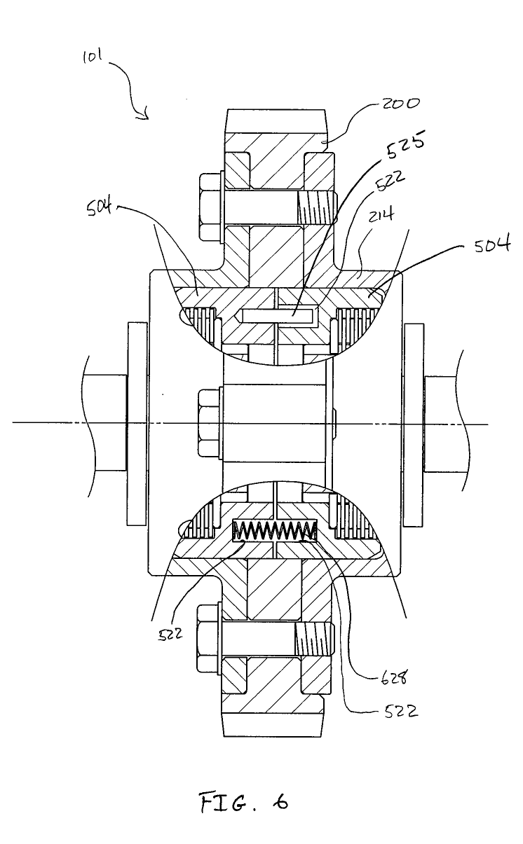

FIG. 6 is a partial cross-sectional view of a differential unit 101 employing the clutch members 504L, 504R of FIG. 5. As shown in FIG. 6, in one embodiment, a biasing spring 628 is disposed within opposing receiving bores 522 to bias the clutch members 504L, 504R apart.

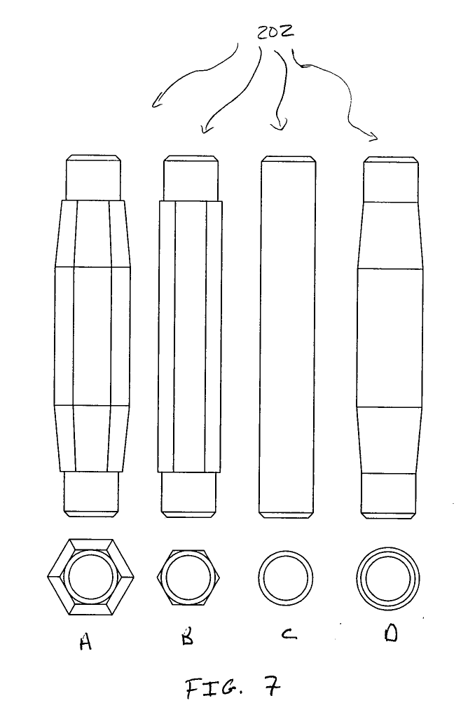

FIGS. 7A-D show alternative cross-shafts 202A, 202B, 202C, and 202D for use in differential unit 101. As is evident by FIG. 7, the cross-shaft may take on various cross-sectional shapes. For example, a simple circular cross-section (as in FIG. 7C) may be employed. However, to optimize contact between cross-shaft 202 and cam surface 206, the cross-section may be modified to a polygonal cross-section, as shown in FIGS. 7A and 7B, or a tapered cross-section as shown in FIGS. 7A and 7D. As shown in FIG. 7D, a portion of cross-shaft 202D has a circular cross-section having a first diameter and another portion of cross-shaft 202D has a circular cross-section with a smaller diameter than the first diameter.

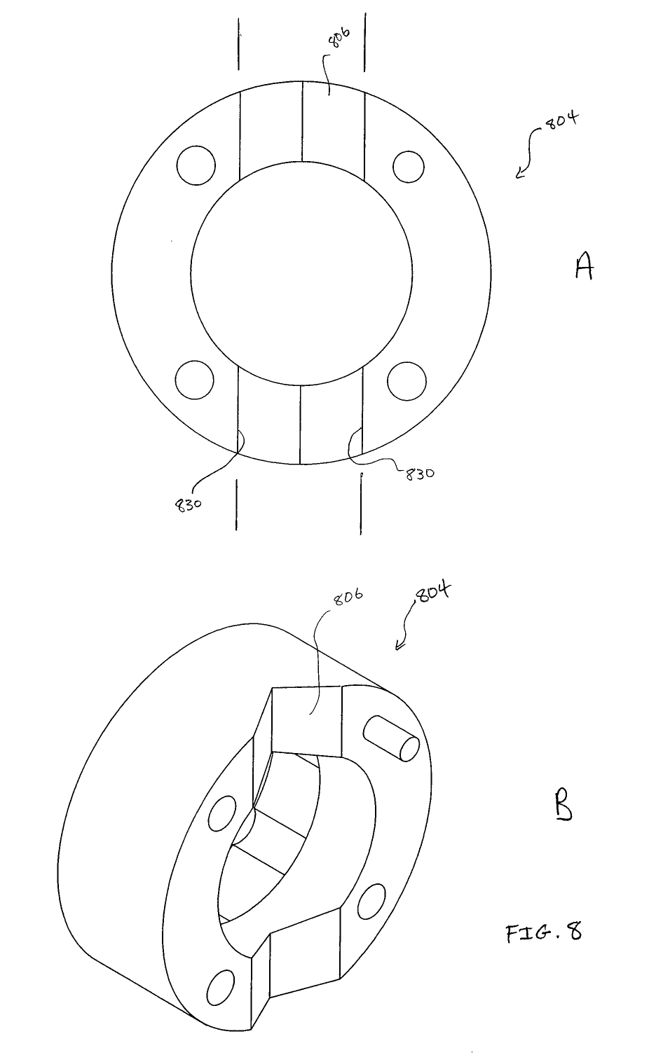

FIGS. 8A and 8B are a side view and a perspective view, respectively, of an alternative clutch member 804. Clutch member 804 is similar to clutch member 504 of FIG. 5, but differs in that the side walls 830 of cam surface 806 are aligned in parallel instead of angled. As such, clutch member 804 is more suitable for use with cross-shafts 202A and 202D of FIG. 7A and FIG. 7D.

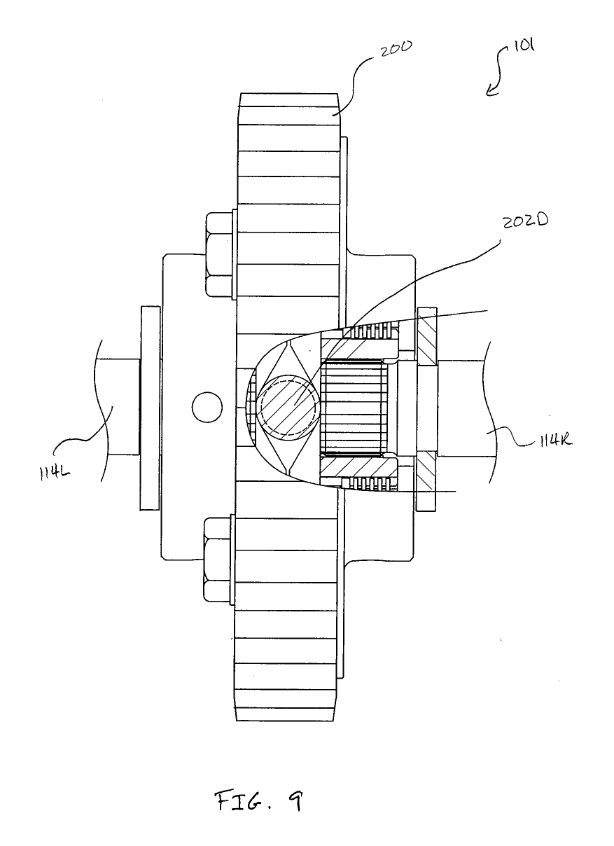

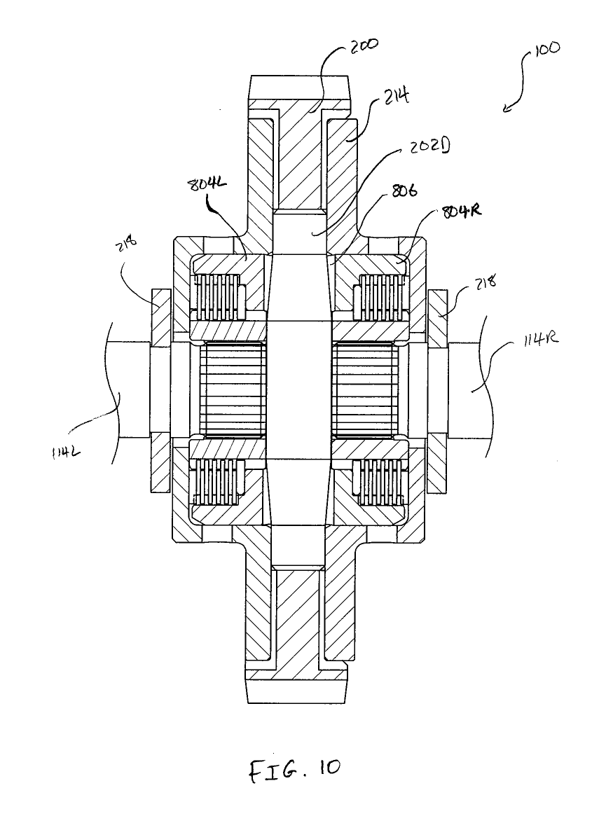

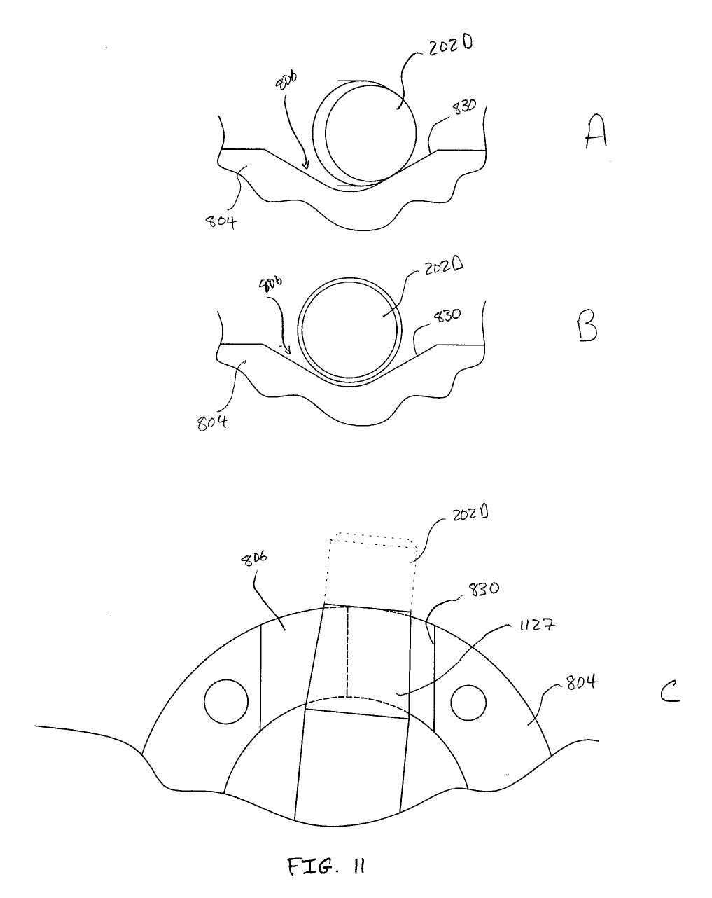

FIG. 9 is a side view, partially in cross-section, of differential unit 101 employing the cross-shaft 202D of FIG. 7D. FIG. 10 is a cross-sectional view of differential unit 101 employing the cross-shaft 202D which provides a modified contact surface between cross-shaft 202D and cam surface 806 of clutch members 804L, 804R. Such a modified contact surface may be employed for purposes of increasing the durability of the differential unit and/or simplicity of manufacture. For example, FIGS. 11A-C are enlarged views of the contact surface between cam surface 806 of clutch member 804 and cross-shaft 202D. FIG. 11B shows cross-shaft 202D in a neutral position. When input gear 200 is rotated, thus rotating cross-shaft 202D, the cross-shaft comes in contact with the side walls 830 of cam surface 806 of clutch member 804. As shown in FIG. 11C, the tapered portion 1127 of cross-shaft 202D moves toward complete and flush contact with side wall 830 of cam surface 806. As such, the side walls 830 of cam surface 806 can be machined in parallel alignment, and yet the contact surface between the clutch member and the cross-shaft can be designed to be flush. Such a design adds to the overall ease of manufacturing differential unit 101.

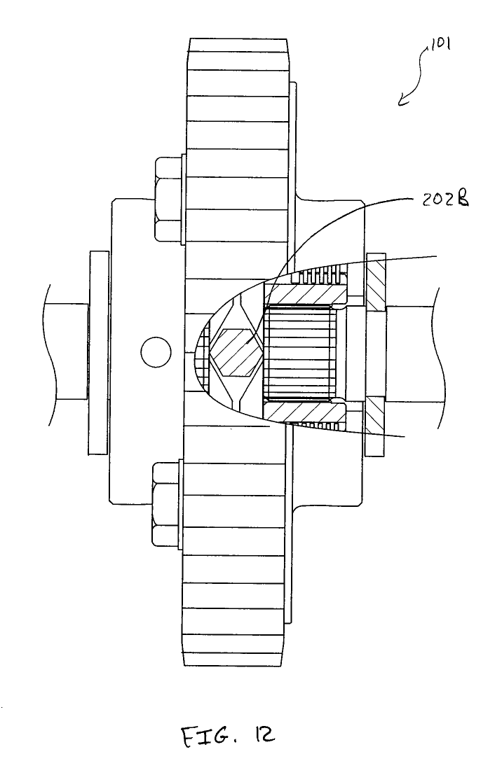

FIG. 12 is a longitudinal sectional view of differential unit 101 employing the cross-shaft 202B of FIG. 7B. As discussed above, and shown in FIG. 12, alternative cross-shafts may be employed to create a modified contact surface between the cross-shaft and the cam surface of the clutch members. Such a modified contact surface may be employed for purposes of increasing the durability of the differential unit and/or simplicity of manufacture.

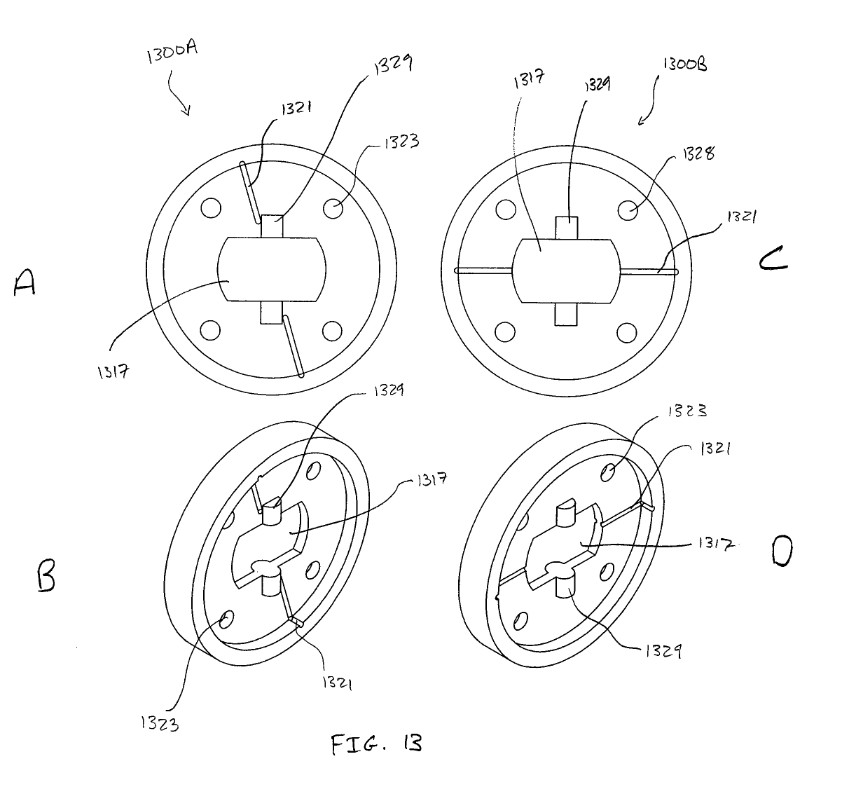

FIGS. 13A-D are side views and a perspective views, respectively, of alternative input gears 1300A, 1300B. Input gear 1300A includes a central opening 1317 for receiving the clutch members therein. Input gear 1300A, however, differs from input gear 200 in that input gear 1300A includes lateral protrusions 1329 which extend from the side surfaces of the input gear. As such, the need for a cross-shaft is negated because the protrusions 1329 align with the cam surfaces of the clutch members to serve the same function as the cross-shaft. The design of input gear 1300A adds flexibility to the design of the differential unit. Input gear 1300A also includes oil channels 1321 to facilitate the circulation of oil through the differential unit. Input gear 1300B differs from input gear 1300A only in the orientation of the oil channels 1321. Bores 1323 are used to bolt a differential housing to the input gear.

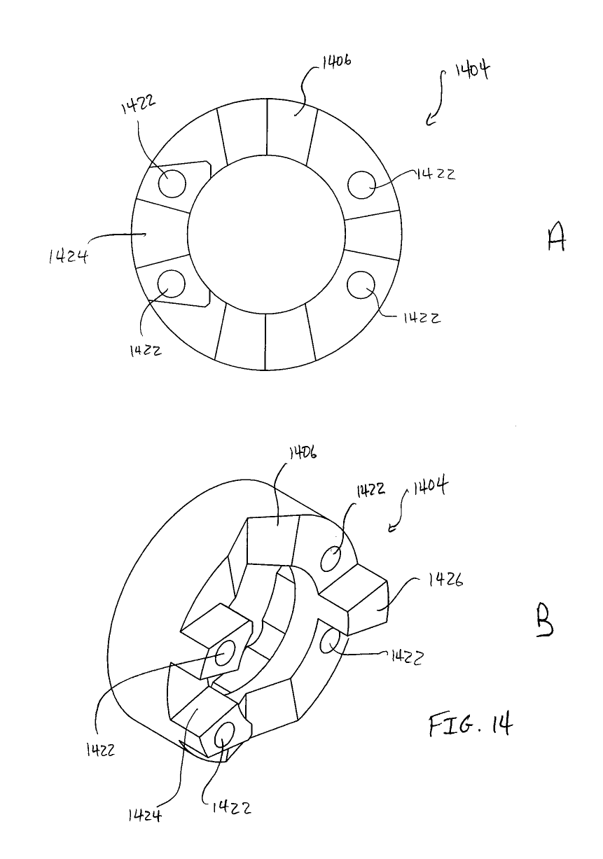

FIGS. 14A and 14B are a side view and a perspective view, respectively, of an alternative clutch member 1404. Clutch member 1404 includes angled cam surface 1406. In a preferred embodiment, one clutch member (1404L or 1404R) includes at least one receiving slot, and the opposite clutch member (1404R or 1404L) includes a locking means extending therefrom. For example, as shown in FIG. 14, clutch member 1404 has a plurality of receiving slots in the form of receiving bores 1422 and receiving wedge 1424. Clutch member 1404 also includes a locking means in the form of locking wedge 1426. In operation, the locking wedge 1426 of one clutch member is aligned with the receiving wedge 1424 in the other clutch member so as to form a loose interlock between the clutch members. For example, the locking wedge 1426 of clutch member 1404L is aligned with and disposed within the receiving wedge 1424 of clutch member 1404R, and vice-versa, so as to form a loose interlock between clutch members 1404L and 1404R. At least one of receiving bores 1422 is used to house a biasing spring, which functions to bias the two clutch members 1404R, 1404L apart.

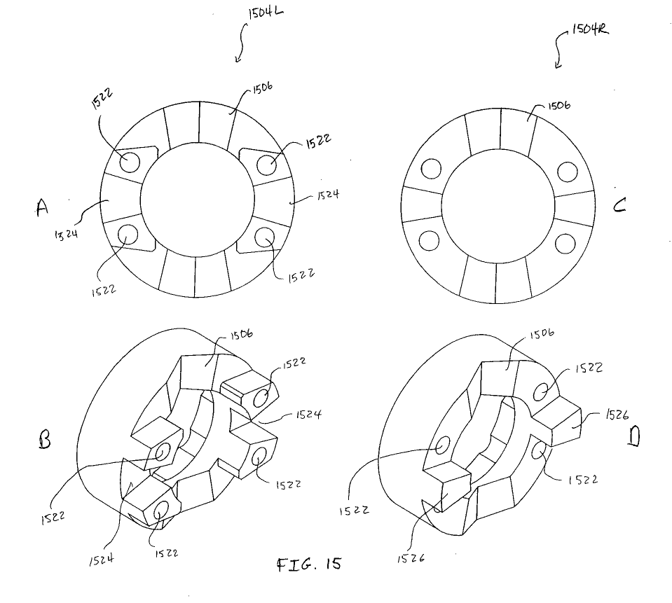

FIGS. 15A-D are side views and a perspective views, respectively, of alternative clutch members 1504R, 1504L. Each clutch member 1504R, 1504L includes an angled cam surface 1506. In a preferred embodiment, one clutch member (1504L or 1504R) includes at least one receiving slot, and the opposite clutch member (1504R or 1504L) includes a locking means extending therefrom. For example, as shown in FIG. 15, clutch member 1504L has a plurality of receiving slots in the form of receiving bores 1522 and receiving wedge 1524. Clutch member 1504R includes a plurality of receiving slots in the form of receiving bores 1522 and a locking means in the form of locking wedge 1526. In operation, the locking wedge 1526 of one clutch member is aligned with the receiving wedge 1524 in the other clutch member so as to form a loose interlock between the clutch members. For example, the locking wedge 1526 of clutch member 1504R is aligned with and disposed within the receiving wedge 1524 of clutch member 1504L, or vice-versa, so as to form a loose interlock between clutch members 1504L and 1504R. At least one of receiving bores 1522 is used to house a biasing spring, which functions to bias the two clutch members 1504R, 1504L apart.

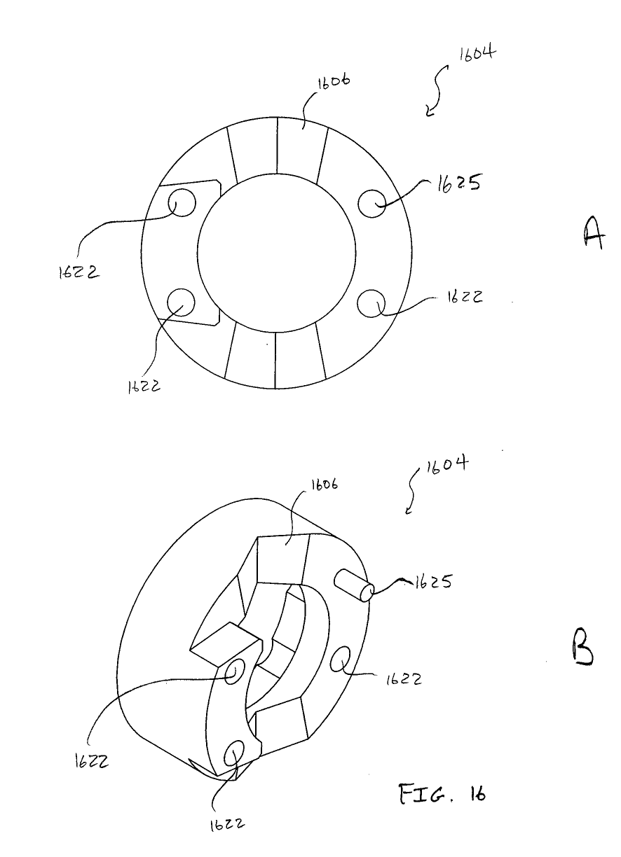

FIGS. 16A and 16B are a side view and a perspective view, respectively, of an alternative clutch member 1604. Clutch member 1604 includes an angled cam surface 1606. In a preferred embodiment, one clutch member (1604L or 1604R) includes at least one receiving slot, and the opposite clutch member (1604R or 1604L) includes a locking means extending therefrom. For example, as shown in FIG. 16, clutch member 1604 has a plurality of receiving slots in the form of receiving bores 1622. Clutch member 1604 also includes a locking means in the form of locking pin 1625 that extends from clutch member 1604. In operation, the locking pin 1625 of clutch member 1604L is aligned with and disposed within a receiving bore 1622 in clutch member 1604R, and vice-versa, so as to form a loose interlock between clutch members 1604L and 1604R. At least one of receiving bores 1622 is used to house a biasing spring, which functions to bias the two clutch members 1604R, 1604L apart.

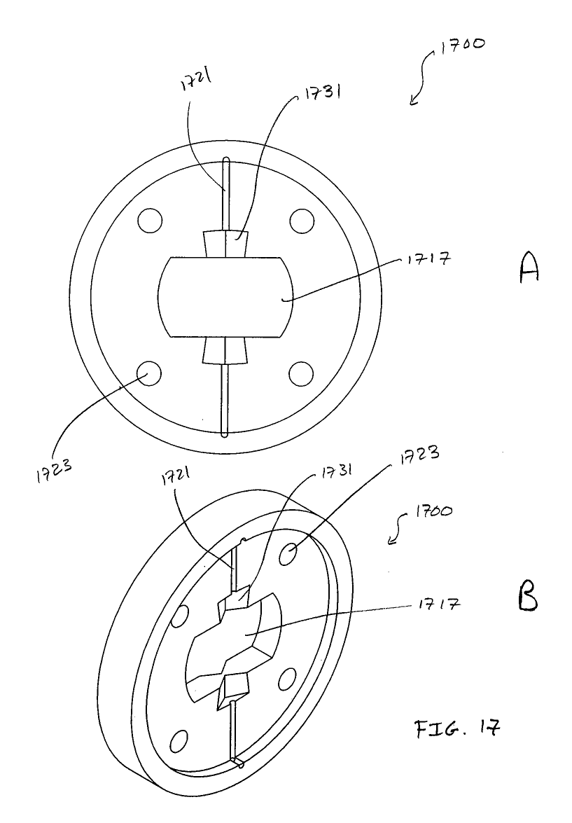

FIGS. 17A and 17B are a side view and a perspective view, respectively, of an alternative input gear 1700. Input gear 1700 includes a central opening 1717 for receiving the clutch members therein. Input gear 1700, however, differs from input gear 200 in that input gear 1700 includes lateral cam surfaces 1731 on each side surface of the input gear. As such, with the use of modified clutch members, the need for a cross-shaft is negated because the cam surfaces 1731 align with protrusions extending from modified clutch members to serve the same function as the cross-shaft. The design of input gear 1700 adds flexibility to the design of the differential unit. Input gear 1700 also includes oil channels 1721 to facilitate the circulation of oil through the differential unit. Bores 1723 are used to bolt a differential housing to the input gear.

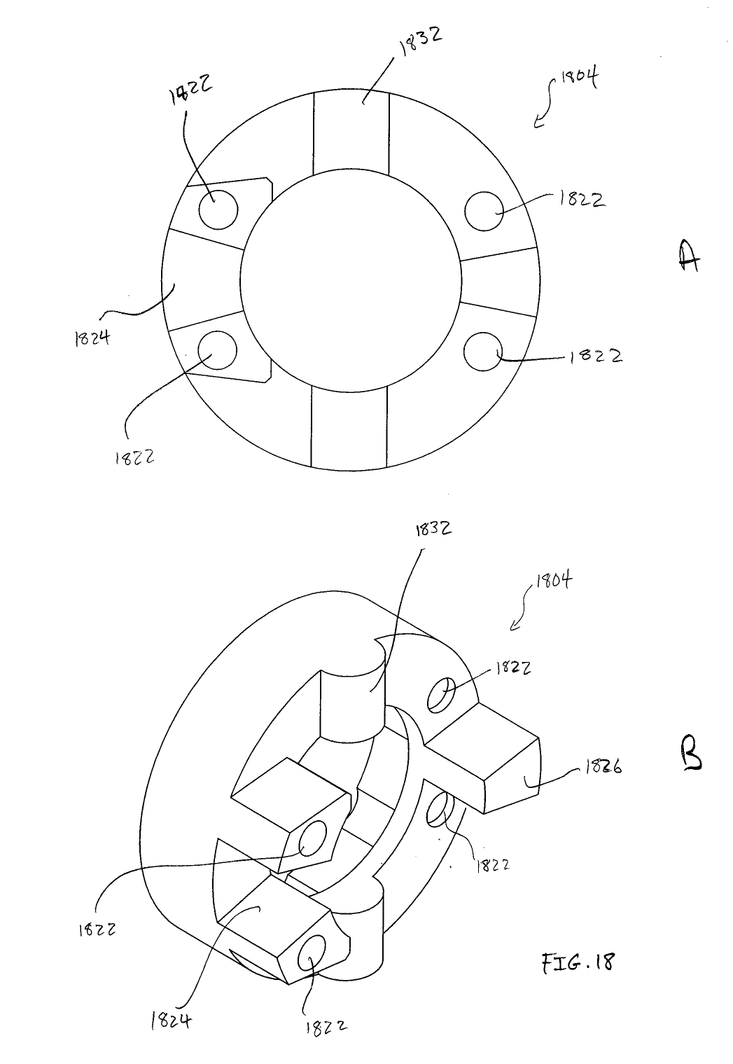

FIGS. 18A and 18B are a side view and a perspective view, respectively, of an alternative clutch member 1804. Clutch member 1804 is similar to clutch member 1404 of FIG. 14. However, clutch member 1804 differs from clutch member 1404 in that clutch member 1404 includes an angled cam surface 1406, while clutch member 1804 includes a protrusion 1832 extending therefrom. As such, clutch member 1804 may be used with input gear 1700. In operation, protrusions 1832 align with lateral cam surfaces 1731 of input gear 1700 to serve the function of cross-shaft 202. Further, as shown in FIG. 18, clutch member 1804 has a plurality of receiving slots in the form of receiving bores 1822 and receiving wedge 1824. Clutch member 1804 also includes a locking means in the form of locking wedge 1826. In operation, the locking wedge 1826 of one clutch member is aligned with the receiving wedge 1824 in the other clutch member so as to form a loose interlock between the clutch members. For example, the locking wedge 1826 of clutch member 1804L is aligned with and disposed within the receiving wedge 1824 of clutch member 1804R, and vice-versa, so as to form a loose interlock between clutch members 1804L and 1804R. At least one of receiving bores 1822 is used to house a biasing spring, which functions to bias the two clutch members 1804R, 1804L apart.

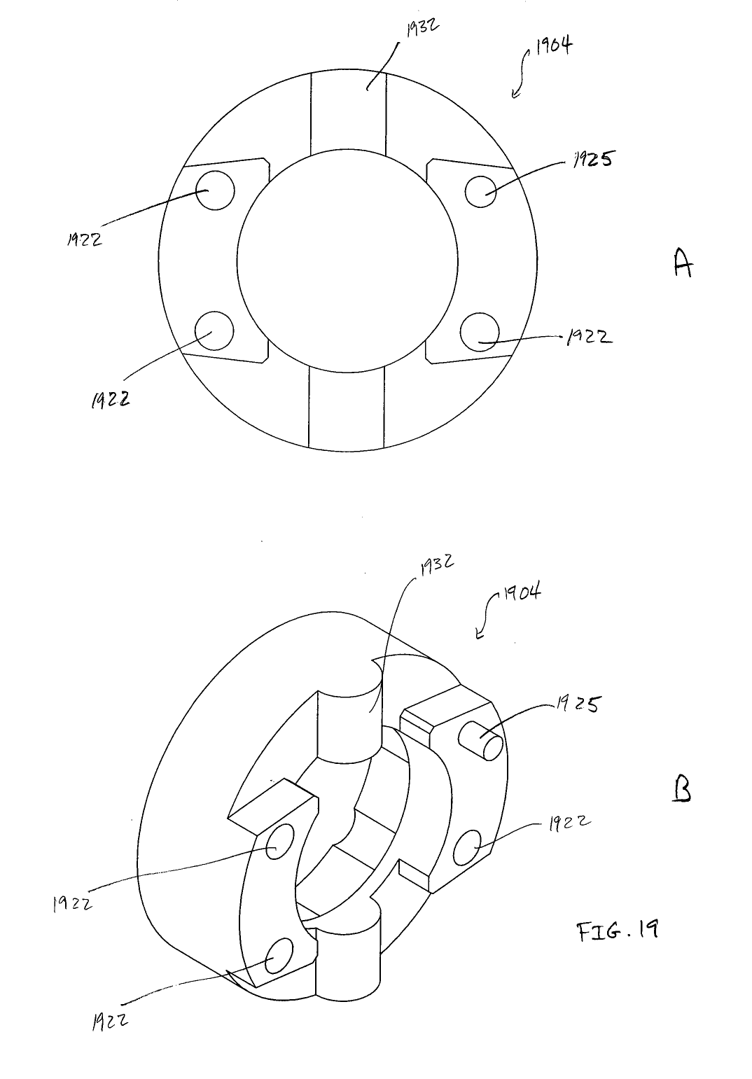

FIGS. 19A and 19B are a side view and a perspective view, respectively, of an alternative clutch member 1904. Clutch member 1904 is similar to clutch member 1604 of FIG. 16. However, clutch member 1904 differs from clutch member 1604 in that clutch member 1604 includes an angled cam surface 1606, while clutch member 1904 includes a protrusion 1932 extending therefrom. As such, clutch member 1904 may be used with input gear 1700. In operation, protrusions 1932 align with the lateral cam surfaces 1731 of input gear 1700 to serve the function of cross-shaft 202. Further, as shown in FIG. 19, clutch member 1904 has a plurality of receiving slots in the form of receiving bores 1922. Clutch member 1904 also includes a locking means in the form of locking pin 1925 that extends from clutch member 1904. In operation, the locking pin 1925 of clutch member 1904L is aligned with and disposed within a receiving bore 1922 in clutch member 1904R, and vice-versa, so as to form a loose interlock between clutch members 1904L and 1904R. At least one of receiving bores 1922 is used to house a biasing spring, which functions to bias the two clutch members 1904R, 1904L apart.

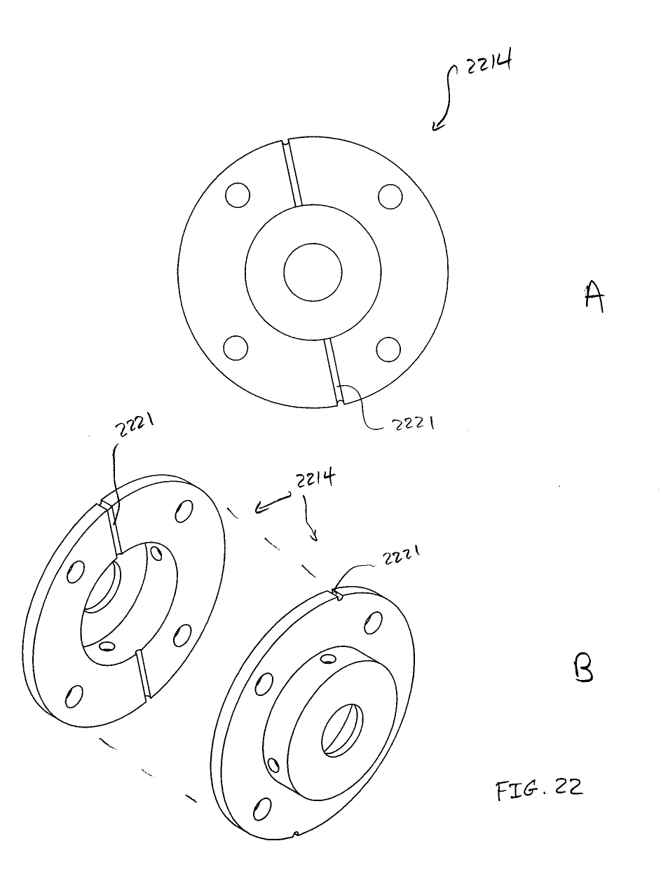

FIGS. 22A and 22B are a side view and a perspective view, respectively, of an alternative differential housing 2214. Oil channels 2221 along the differential housing 2214 negate the need for oil channels 321 on input gear 200.

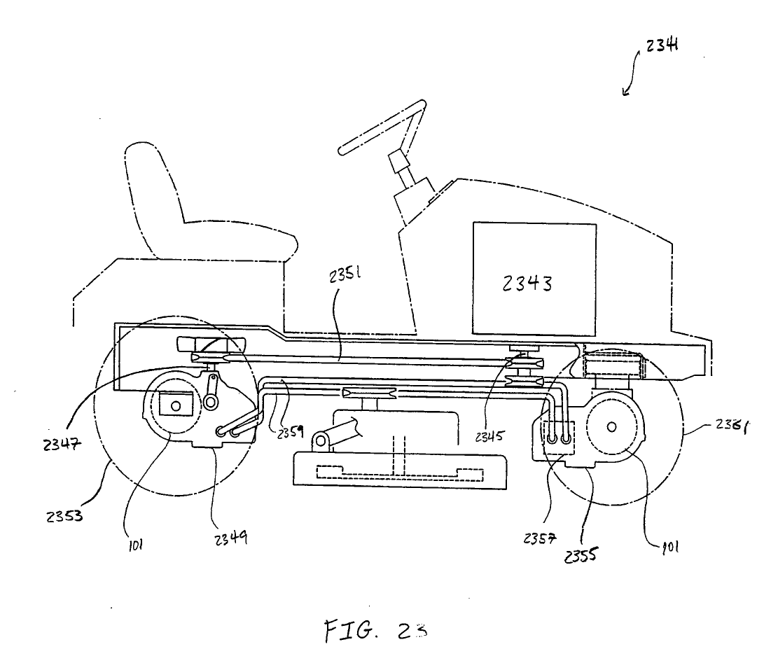

FIG. 23 is a four-wheel-drive working vehicle 2341 mounting a differential unit 101 as presented herein. Working vehicle 2341 includes an engine 2343 having a vertical output shaft 2345. Engine 2343 delivers drive power to a vertical input shaft 2347 of a rear transaxle 2349 (such as IHT 100 described above) through a pulley-belt combination 2351. As would be evident to one of skill in the art, alternative drive trains, such as mechanical shafts, may be employed as alternatives to pulley-belt combination 2351. Rear transaxle 2349 is a drive system combining an IHT with any of the differential unit 101 embodiments discussed above. Rear transaxle 2349 serves to drive rear wheels 2353.

Working vehicle 2341 further includes a front transaxle 2355. Front transaxle 2355 is a drive system combining a hydraulic motor 2357 with any of the differential unit 101 embodiments described above. Front transaxle 2355 serves to drive front wheels 2361. Hydraulic motor 2357 of front transaxle 2355 is fluidly connected to and driven by the IHT of rear transaxle 2349 through hydraulic fluid lines 2359. As such, hydraulic fluid lines 2359 serve as a drive train between rear transaxle 2349 and front transaxle 2355. A similar drive system is described in U.S. Pat. No. 6,845,837, which is hereby incorporated in its entirety by reference thereto. Alternative drive trains between front and rear transaxles, such as the mechanical shaft drive train described in U.S. Pat. No. 6,902,017, and the hydraulic drive train described in U.S. Pat. No. 4,886,142, may also be used. The disclosures of U.S. Pat. Nos. 4,886,142 and 6,902,017 are hereby incorporated by reference in their entirety. Further, while the vehicle shown is of an Ackermann steering type, the differential units described may be employed in other vehicles such as a vehicle of articulate steering type.

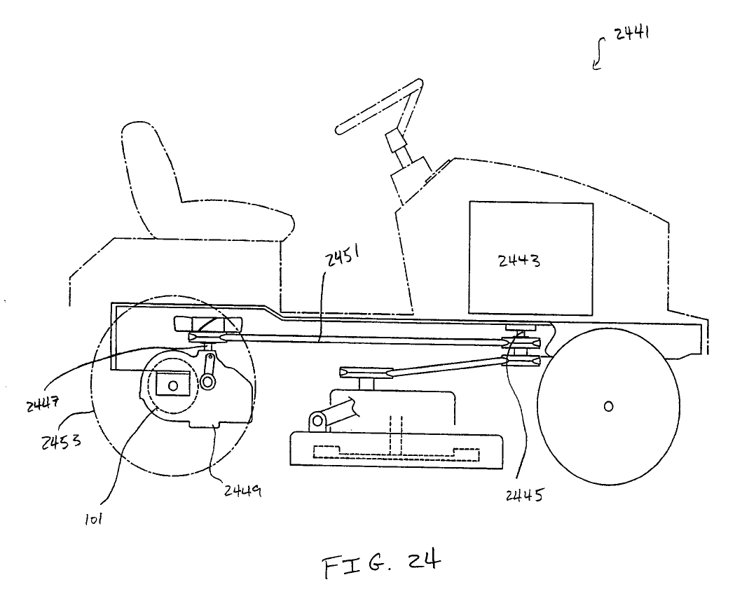

FIG. 24 is a two-wheel-drive working vehicle 2441 employing a differential unit 101 as presented herein. Working vehicle 2441 includes an engine 2443 having a vertical output shaft 2445. Engine 2443 delivers drive power to a vertical input shaft 2447 of a rear transaxle 2449 (such as IHT 100 described above) through a pulley-belt combination 2451. As would be evident to one of skill in the art, alternative drive trains, such as mechanical shafts, may be employed as alternatives to pulley-belt combination 2451. Rear transaxle 2449 is a drive system combining an IHT with any of the differential unit 101 embodiments discussed above. Rear transaxle 2449 serves to drive rear wheels 2453.

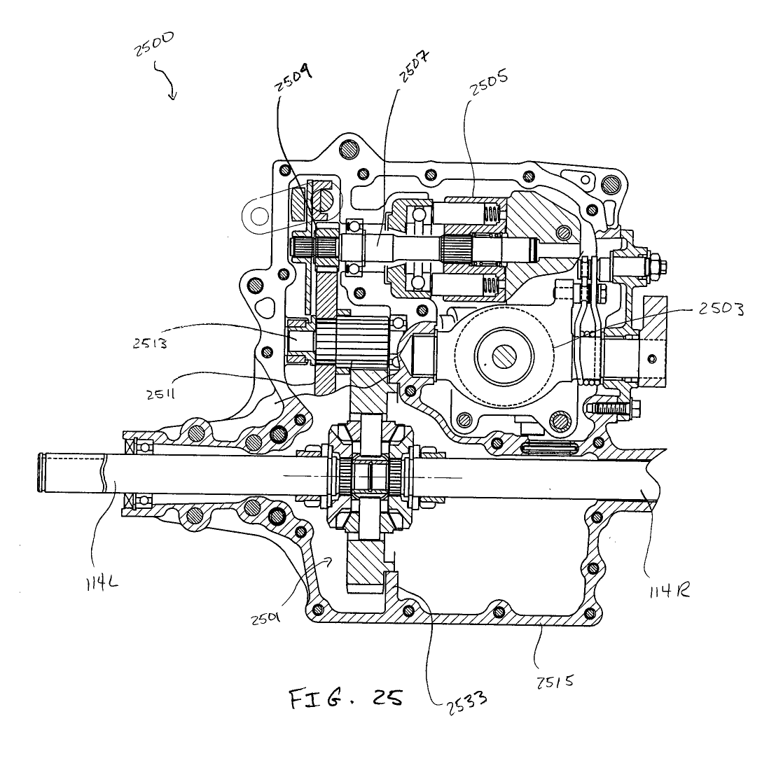

FIG. 25 is a cross-sectional view of an IHT 2500 employing an alternative differential unit 2501. Similar to FIG. 1, FIG. 25 depicts an IHT 2500 employing a hydraulic pump 2503 (shown in phantom) and a hydraulic motor 2505 fluidly connected to the hydraulic pump 2503. Hydraulic motor 2505 includes an output shaft, or motor shaft 2507. Splined gear 2509 is mounted on motor shaft 2507, to thereby rotate with motor shaft 2507. Splined gear 2509 meshes with gear 2511 mounted on countershaft 2513. Rotation of countershaft 2513 thereby transmits rotational drive to differential unit 2501. Differential unit 2501 thereafter differentially drives axle shafts 114L and 114R. The components of IHT 2500 are all appropriately mounted and maintained within IHT housing 2515. Specifically, housing 2515 includes a lip 2533 to support differential unit 2501.

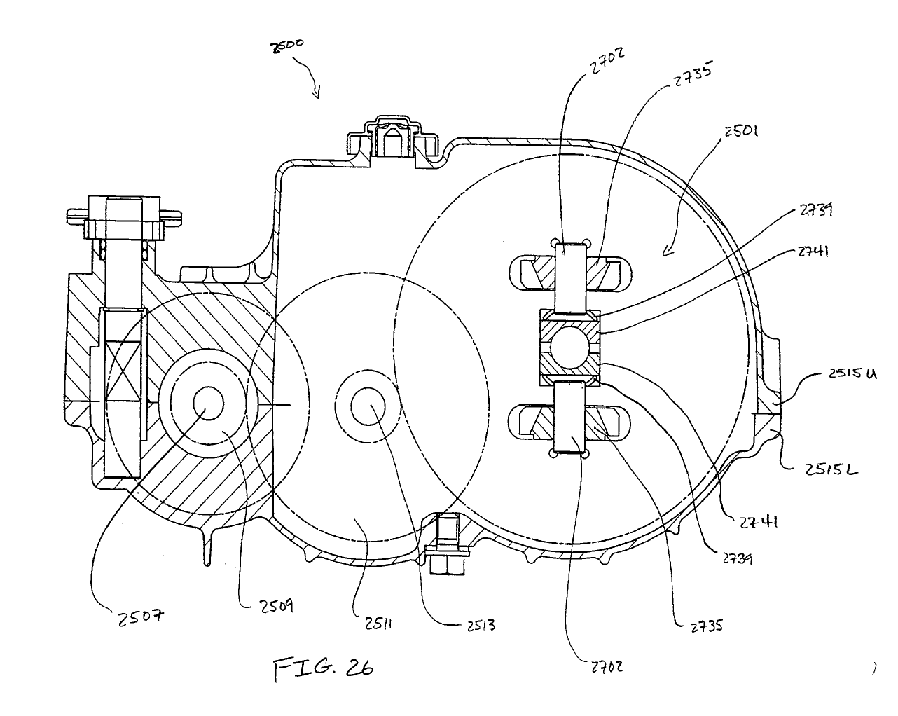

FIG. 26 is a cross-sectional view of IHT 2500 of FIG. 25. FIG. 26 provides an alternative view as to how gears 2509 and 2511 mesh to ultimately rotate the differential unit 2501. As shown in FIG. 26, housing 2515 is split between an upper housing 2515U and a lower housing 2515L. Upper and lower housings are then fastened together by appropriate means, such as a bolt.

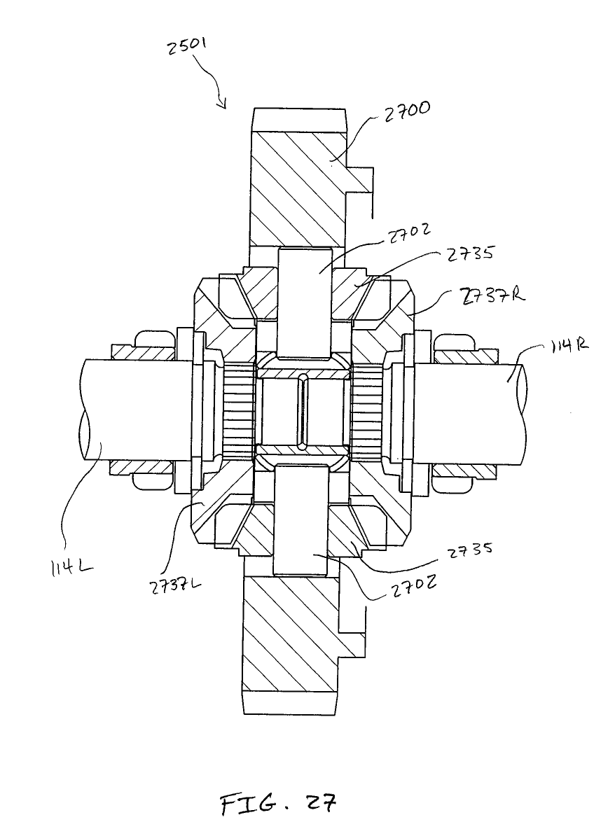

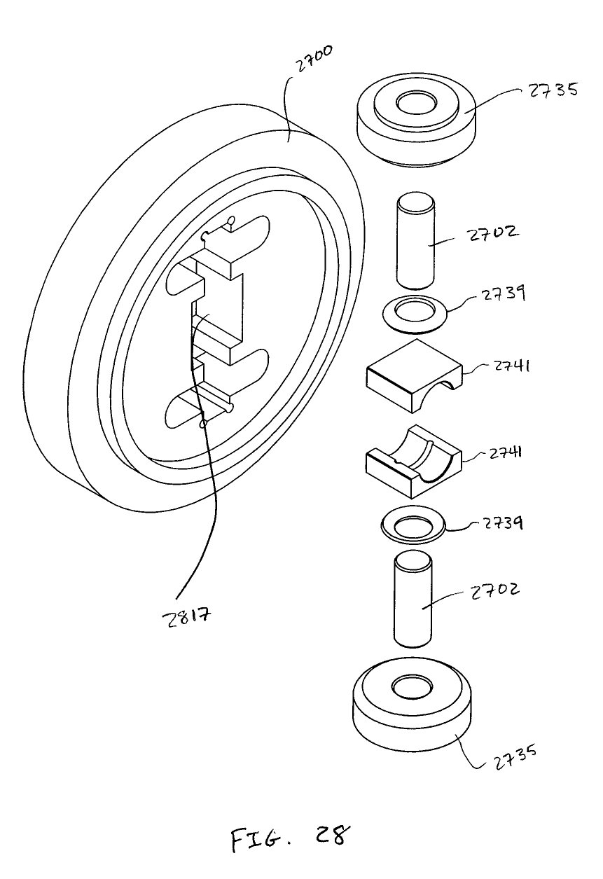

FIG. 27 is a cross-sectional view of the differential unit 2501 of FIG. 25. Differential unit 2501 includes an input gear 2700 having a central opening 2817 (as shown in FIG. 28). Two cross-shafts 2702 are disposed within the central opening of the input gear 2700 and are interlocked with the input gear such that rotation of the input gear rotates the cross-shafts. Mounted on each cross-shaft 2702 is a pinion gear 2735. Pinion gears 2735 mesh with left and right output gears 2737L, 2737R, which in turn are in splined engagement with left and right axle shafts 114L, 114R.

Differential unit 2501 also includes a pair of coned disk springs 2739 and a pair of friction members 2741. Friction members 2741 surround the end portions of axle shafts 114L, 114R. Coned disk springs 2739 serve to press friction members 2741 against the end portions of axle shafts 114L, 114R. As such, under normal operating conditions, rotation of input gear 2700 causes rotation of both axle shafts 114L, 114R. During turning conditions, differential unit 2501 acts as a standard differential unit. However, during free-wheel conditions, the friction members 2741 serve to lock axle shafts 114L, 114R so that both axle shafts rotate together. Thus friction members 2741 serve as a differential locking means for differential unit 2501. FIG. 28 is an exploded view of the differential unit 2501 of FIG. 25 showing how the pinion gears 2735, cross-shafts 2702, coned disk springs 2739 and friction members 2741 are aligned within the central opening 2817 of the input gear 2700.

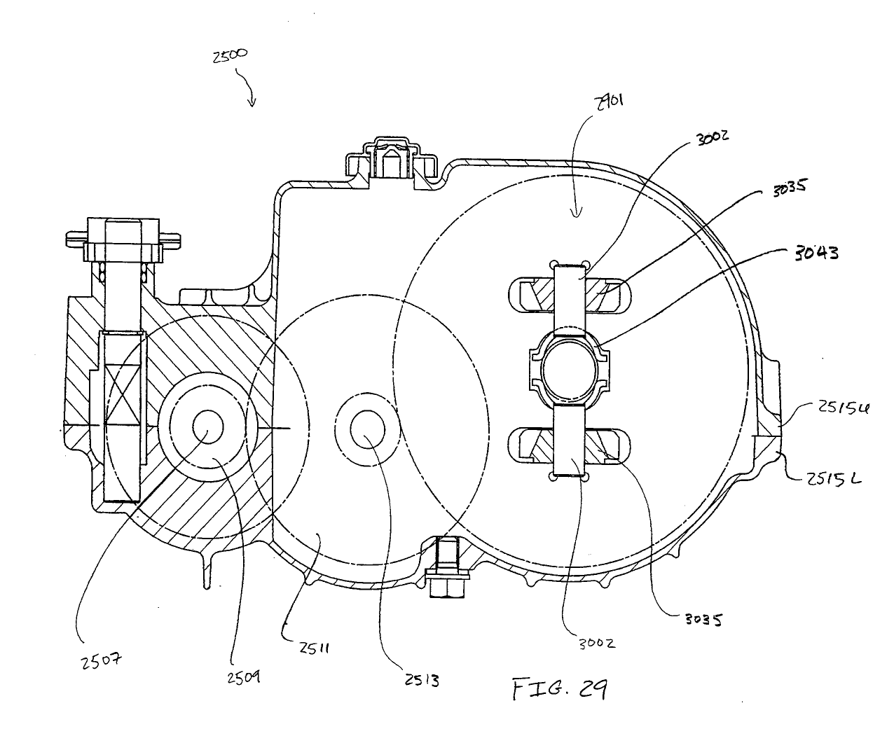

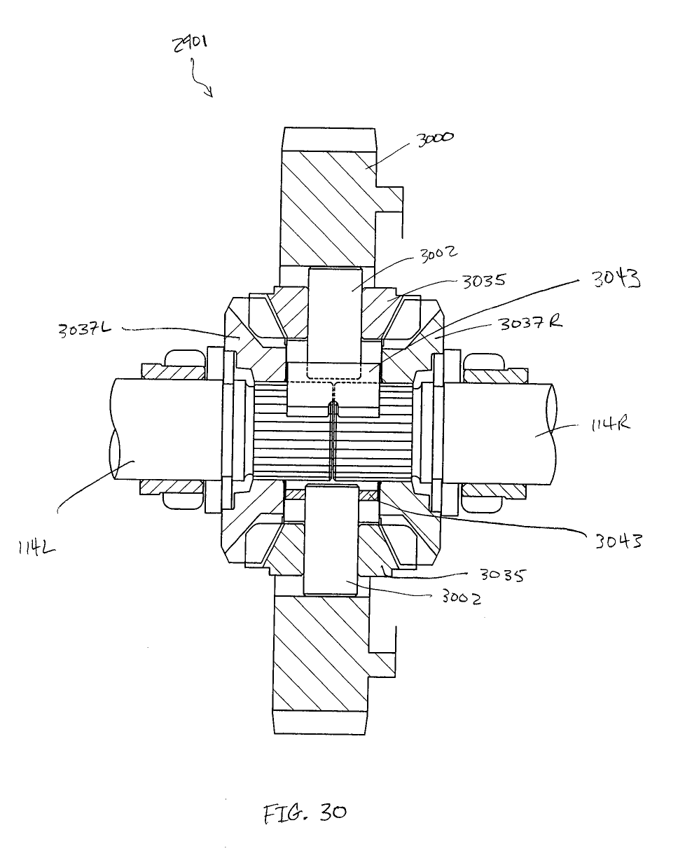

FIG. 29 is a cross-sectional view of IHT 2500 (of FIG. 25) incorporating an alternative differential unit 2901. FIG. 30 is a cross-sectional view of the differential unit 2901 of FIG. 29. Differential unit 2501 includes an input gear 3000 having a central opening 3117 (as shown in FIG. 28). Two cross-shafts 3002 are disposed within the central opening of the input gear 3000 and are interlocked with the input gear such that rotation of the input gear rotates the cross-shafts. Mounted on each cross-shaft 3002 is a pinion gear 3035. Pinion gears 3035 mesh with left and right output gears 3037L, 3037R, which in turn are in splined engagement with left and right axle shafts 114L, 114R.

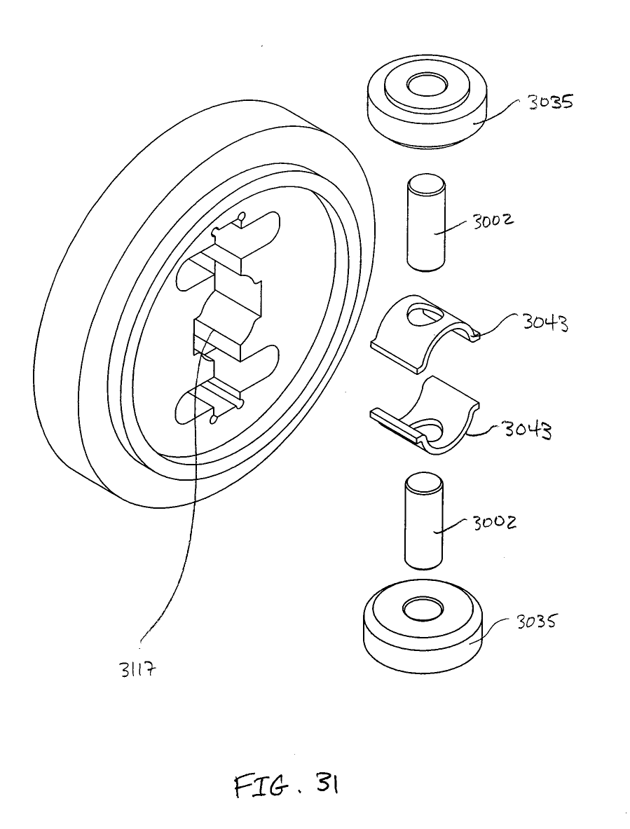

Differential unit 2901 also includes a pair of friction springs 3043. Friction springs 3043 surround the end portions of axle shafts 114L, 114R. As such, under normal operating conditions, rotation of input gear 3000 causes rotation of both axle shafts 114L, 114R. During turning conditions, differential unit 2901 acts as a standard differential unit. However, during free-wheel conditions, the friction springs 3043 serve to lock axle shafts 114L, 114R so that both axle shafts rotate together. Thus friction springs 3043 serve as a differential locking means for differential unit 2901. FIG. 31 is an exploded view of the differential unit 2901 of FIG. 29 to show how the pinion gears 3035, cross-shafts 3002, and friction springs 3043 are aligned within the central opening 3117 of the input gear 3000.

### CONCLUSION

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

While various embodiments of an axle driving apparatus have been described, it should be understood that they have been presented by way of example, and not limitation. It will be apparent to a person skilled in the relevant art that various changes in form and detail can be made therein without departing from the spirit and scope of the appended claims. Thus the present invention should not be limited by any of the above-described exemplary embodiments, but should be defined only in accordance with the following claims and their equivalents.

What is claimed is:

1. An axle driving apparatus comprising:
a housing;
a hydraulic pump contained within the housing and drivingly connected to a prime mover;
a hydraulic motor contained within the housing, the hydraulic motor being fluidly connected to the hydraulic pump, and wherein the hydraulic motor includes an output shaft;
a differential unit contained within the housing and drivingly connected to the output shaft of the hydraulic motor, wherein the differential unit comprises:
an input gear having a central opening;
a cross-shaft disposed within the central opening of the input gear and interlocked with the input gear such that rotation of the input gear rotates the cross-shaft;
a pair of clutch members disposed coaxially with the input gear, one of each clutch members disposed on opposite sides of the cross-shaft, each clutch member including a cam surface which comes in contact with the cross-shaft when the differential unit is under normal operating conditions;
a first friction member extending from each clutch member;
a pair of side couplings, each coaxially disposed within one of the clutch members; and
a friction member extending from each side coupling, wherein the second friction member is disposed proximate the first friction member for selective engagement therewith; and
a pair of axle shafts driven by the differential unit and contained within the housing.

2. An axle driving apparatus as set forth in claim 1, wherein the cross-shaft has a polygonal cross-section.

3. An axle driving apparatus as set forth in claim 1, wherein a portion of the cross-shaft has a circular cross-section having a first diameter and another portion of the cross-shaft has a circular cross-section with a smaller diameter than the first diameter.

4. An axle driving apparatus as set forth in claim 1, wherein the housing includes oil for the input gear to soak, and the input gear includes an oil channel along a side surface thereof.

5. An axle driving apparatus as set forth in claim 1, further comprising:
a differential housing encasing the input gear, the pair of clutch members, and the pair of side couplings.

6. An axle driving apparatus as set forth in claim 5, wherein the housing includes oil for the input gear to soak, and the differential housing includes an oil channel formed along a surface of the differential housing.

7. An axle driving apparatus as set forth in claim 5, wherein the housing includes oil for the input gear to soak, and the differential housing includes an oil bore transecting through a portion of the differential housing to facilitate the circulation of oil through the differential unit.

8. An axle driving apparatus as set forth in claim 1, wherein one clutch member includes at least one receiving slot, and the other clutch member includes a locking means extending therefrom, wherein the locking means is aligned with the receiving slot in the first clutch member so as to form a loose interlock between the clutch members, and wherein a spring is disposed within at least one receiving slot and biases the two clutch members apart.

9. A differential unit for driving a pair of axle shafts, comprising:
an input gear having a central opening and an oil channel along a side surface thereof;
a cross-shaft disposed within the central opening of the input gear and interlocked with the input gear such that rotation of the input gear rotates the cross-shaft;
a pair of clutch members disposed coaxial with the input gear, one of each clutch members disposed on opposite sides of the cross-shaft, each clutch member including a cam surface which comes in contact with the cross-shaft when the differential unit is under normal operating conditions;
a first friction member extending from each clutch member;
a pair of side couplings, each coaxially disposed within one of the clutch members; and
a second friction member extending from each side coupling, wherein the second friction member is disposed proximate the first friction member for selective engagement therewith.

10. A differential unit as set forth in claim 9, further comprising:
a differential housing encasing the input gear, the pair of clutch members, and the pair of side couplings.

11. A differential unit as set forth in claim 10, wherein the differential unit is contained within a housing, and the housing includes oil for the input gear to soak, and the differential housing includes an oil bore transecting through a portion of the differential housing to facilitate the circulation of oil through the differential unit.

12. A differential unit as set forth in claim 9, wherein one clutch member includes at least one receiving slot, and the other clutch member includes a locking means extending therefrom, wherein the locking means is aligned with the receiving slot in the first clutch member so as to form a loose interlock between the clutch members, and wherein a spring is disposed within at least one receiving slot and biases the two clutch members apart.

13. A differential unit for driving a pair of axle shaft segments, comprising:
an input gear having
(i) a central opening, and
(ii) a protrusion extending from each side surface of the input gear;
a pair of clutch members disposed coaxial with the input gear and on opposite sides of the input gear, each clutch member having a cam surface aligned proximate with the protrusion extending from the respective side surface of the input gear for selective engagement, and wherein the clutch members loosely interlock with each other through the central opening of the input gear;
a first friction member extending from each clutch member;
a pair of side couplings, each coaxially disposed within one of the clutch members; and
a second friction member extending from each side coupling, wherein the second friction member is disposed proximate the first friction member for selective engagement.

14. A differential unit as set forth in claim 13, wherein the differential unit is contained within a housing, and the housing includes oil for the input gear to soak, and the input gear includes an oil channel along a side surface thereof.

15. A differential unit as set forth in claim 14, wherein the oil channel extends from near the central opening of the input gear to an outer edge of the input gear.

16. A differential unit as set forth in claim 13, further comprising:
a differential housing encasing the input gear, pair of clutch members, and pair of side couplings.

17. A differential unit as set forth in claim 16, wherein the differential unit is contained within a housing, and the housing includes oil for the input gear to soak, and the differential housing includes an oil channel formed along a surface of the differential housing.

18. A differential unit as set forth in claim 16, wherein the differential is contained within a housing, and the housing includes oil for the input gear to soak, and the differential housing includes an oil bore transecting through a portion of the differential housing to facilitate the circulation of oil through the differential unit.

19. A differential unit as set forth in claim 13, wherein one clutch member includes at least one receiving slot, and the other clutch member includes a locking means extending therefrom, wherein the locking means is aligned with the receiving slot in the first clutch member so as to form a loose interlock between the clutch members, and wherein a spring is disposed within at least one receiving slot and biases the two clutch members apart.

20. A differential unit for driving a pair of axle shaft segments, comprising:
an input gear having
(i) a central opening, and
(ii) a cam surface on each side surface of the input gear;
a pair of clutch members disposed coaxial with the input gear and on opposite sides of the input gear, each clutch member having a protrusion extending from a surface of the clutch member, the protrusion on each clutch member aligned with the cam surface on the respective side surface of the input gear, and wherein the clutch members are loosely interlocked with each other through the central opening of the input gear;
a first friction member extending from each clutch member;
a pair of side couplings, each coaxially disposed within one of the clutch members; and
a second friction member extending from each side coupling, wherein the second friction member is disposed proximate the first friction member for selective engagement.

21. A differential unit as set forth in claim 20, wherein the differential unit is contained within a housing, and the housing includes oil for the input gear to soak, and the input gear includes an oil channel along a side surface thereof.

22. A differential unit as set forth in claim 20, further comprising:
a differential housing encasing the input gear, pair of clutch members, and pair of side couplings.

23. A differential unit as set forth in claim 22, wherein the differential unit is contained within a housing, and the housing includes oil for the input gear to soak, and the differential housing includes an oil channel formed along a surface of the differential housing.

24. A differential unit as set forth in claim 22, wherein the differential unit is contained within a housing, and the housing includes oil for the input gear to soak, and the differential housing includes an oil bore transecting through a portion of the differential housing to facilitate the circulation of oil through the differential unit.

25. A differential unit as set forth in claim 20, wherein one clutch member includes at least one receiving slot, and the other clutch member includes a locking means extending therefrom, wherein the locking means is aligned with the receiving slot in the first clutch member so as to form a loose interlock between the clutch members, and wherein a spring is disposed within at least one receiving slot and biases the two clutch members apart.
